(19) United States
(12) Patent Application Publication
(10) Pub. No.: US 2006/0192979 A1
(43) Pub. Date: Aug. 31, 2006

(54) Optical measuring process and precision measuring machine for determining the deviations from ideal shape of technically polished surfaces

(76) Inventors: Heiner Lammert, Mahlow (DE); Tino Noll, Berlin (DE); Thomas Schlegel, Berlin (DE); Frank Siewert, Berlin (DE); Thomas Zeschke, Berlin (DE)

Correspondence Address: LAW OFFICES OF KARL HORMANN, 86 SPARKS STREET, CAMBRIDGE, MA, 02138, US

(21) Appl. No.: 10/543,423

(22) PCT Filed: Jan. 15, 2004
(86) PCT No.: PCT/DE04/00102

§ 371 Date: Jul. 25, 2005

(30) Foreign Application Priority Data
Jan. 23, 2003 (DE) DE 103 03 659.8

(51) Int. Cl. G01B 11/24

(52) U.S. Cl. 356/612

(57) ABSTRACT

In a known measuring process, the stability for the generation of two measuring beams, by means of two measuring systems operating in the same measurement strategy is given. The reflection angle of the measuring beams deflected onto a blank are detected as inclination deviations of the surface and analyzed by difference. Systematic measuring deviations are conventionally reduced however mainly by the use of a single measuring strategy or system with a moving measuring beam. According to the invention, the measurement accuracy can be improved by combining two measuring strategies in the measuring process, carried out by different measuring systems (13, 14), which can be an autocollimator (AKF) and a long-trace profilometer)LTP), the measuring beams of which can be directed at the blank (10) using different types of deflecting units (15). Measured results with an accuracy of up to 0.01 angle seconds, hence sub-nanometer range, for example +/−0.2 nm, can be achieve by means of suitable correlation of the measured values obtained from the different scanning methods for offsetting the systematic measuring deviations of both measuring systems (13, 14). Precisely produced surfaces of almost any dimensions, for example, nanometer optical components can thus be highly precisely inspected.

The invention relates to an optical measuring method of determining deviations from the ideal of technically polished surfaces with a planar or curved contour of a slidably mounted specimen by reference-free optical scanning with at least two measuring beams each of which is deflected to the surface of the specimen by a slidable beam deflection unit detected by the respective angle of reflection, and to a precision measuring apparatus for carrying out the measuring method.

The requirements placed on a measuring method of this kind and on the precision measuring apparatus carrying it out are extremely high. In general, the technical surfaces to be measured have a constant contour and may be planar or arbitrarily curved. However, the surfaces may also be provided with cracks and displacements. With such characteristics, the technical surfaces in their generally multifarious shapes constitute an essential feature of technical components. The extraordinary speciality of their features relates to the generality of the possible shapes, the dimensions of the technical components and the precise maintenance of precision of the shape. Fields of application to be mentioned of such technical components may be, for instance, the automotive industry, the turbine industry or optics. Possible applications of high precision measuring methods and precision measuring apparatus for practicing the method are individual and repetitive manufacture, identification at manufacturers and users as well as use in research and development. In the automotive industry, during the course of technical development, crank shafts, cylinders or pistons have increasingly complex functional surfaces deviating in their desired shape or as a result of wear or under differing temperature conditions from exact mathematical cylindrical shapes. Although such deviations may be very small, yet the requirements regarding to their precision as dictated by their intended use set limits in respect of measurement uncertainties of up the 10 nm. In the turbine industry, the shaping of the structure of turbine vanes, fans or ships' propellers is optimized at a very high differentiation by methods of finite element calculations. The surfaces shapes of aspheric free forms required in connection with such structures may be fabricated by extremely precise numerically controlled machine tools so that the determination of such deviations of shape also requires measurement uncertainties not exceeding 10 nm. Inherent in optical manufacture and testing is the requirement for a highly precise definition of the shape of light conducting and converting components such as, for examples, mirrors, lenses, optical grids. The traditional form measuring accuracy of such components in the order of 50 nm, nowadays is in many cases required to be 5 nm. Furthermore, currently and in future aspheric rotationally symmetric or non rotationally symmetric surface shapes which are subject to high demands of precision, are gaining increasing importance. Moreover, there is a need for extreme extensions of optical components. For use in research with synchrotron radiation aspheric mirrors of rectangular configuration are necessary which exceed 1,000 mm in length and which are of the greatest possible accuracy of form. The application of reflecting and dispersing components for extremely ultraviolet light of wavelengths in the order 0.1 nm to 10 nm for use in photon lithography calls for aspheric surfaces of a precision under 1 nm. As a result of the required accuracies of the shapes of such components their surfaces often are of such micro roughness that they reflect light, i.e. that they are quasi polished. The reflectance of these surfaces depends upon the material of which the components are made and upon their coating.

In respect of the reflectance of the surfaces to be measured, the field of application of the present invention spans the range of wave lengths of visible light between 100% as with metals, such as, for example, steel or gold, and 4% as in the case of optical glass, or even lower. The applications of contactless measuring methods furthermore extend to very sensitively coated components with layer thicknesses of less than 100 nm which could easily be damaged by contact measuring methods.

Measuring apparatus involving the transformation of mechanical or optically contacting measuring methods are known in the prior art; they either compare the entire surface to be measured simultaneously against a reference surface (interferometric measuring methods) or they raster the surface point by point (deflectometric measuring methods). Measuring apparatus involving mechanical contact are known as well. Among these is the coordinate measuring apparatus known from German patent specification DD 218,667 B1 which for eliminating deviations of measurements is provided with a bilaterally effective mechanical sensing system for carrying out localized difference measurements on a specimen against a real or virtual reference forming reference element. The optical interferometric measuring methods require reference surfaces shaped like the surface to be measured which for differently curved, for example aspherically curved surfaces require a plurality of different configurations of the reference surface. However, the reference surfaces limit the accuracy of the results of the measurements. The claimed measuring method is to be considered to be an optically contacting deflectometric measuring methods. The simple rastering of surfaces according to the deflectometric method also includes a number of systematic and accidental deviations of measurement (measurement error).

German patent specification DE 197 20 122 C2 discloses an optical contact-free method for determining an optical measuring value and is based upon establishing the difference between two constantly spaced measuring values. In principle, this shearing method is based upon the detection of a difference between two measuring values using a single optical measuring method. Based upon this, a measuring method requiring neither a reference nor calibration and a measuring system are known from German patent specification DE 198 33 269 C1 for the high-precision determination, reaching into the range of several nm, of the topography of a surface which is at least approximately planar, in which two consecutive measurements are taken by a single measuring system for measuring an angle difference. By applying the basic principle of difference measurement, systematic measurement deviations which would be additively introduced into the measurements are eliminated. It is true that the mentioned publication also teaches the use of two beam generating measuring apparatus for generating measuring beams with a shearing distance for carrying out such difference measurements. This is expressly described, however, as being disadvantageous since the resulting deviations cannot be compensated. Thus, the mentioned publication suggests angle measuring including a measuring strategy converted by an autocollimator in which a pentagonal prism is used as a beam deflector. Such a prism is substantially invariant with respect to inclinations of its reflective surfaces, but it has manufacturing tolerances which may result in systematic measurement deviations. Since, in addition, deviations may occur about the axis in the scanning direction during measurement as a result of an incorrect alignment relative to the angle, the publication proposes an arrangement in which in addition to the measuring autocollimator two more autocollimators are provided which are arranged in alignment with the measuring autocollimator and in a plane at a right angle relative thereto. At this point it is to be expressly mentioned, however, that rather than receiving measuring values, the two autocollimators serve only to correct the angle of the pentagonal prism. Measuring the difference is carried out by one and the same autocollimator by shifting the measuring head. The actual aim of the mentioned publication is to avoid the use of several measuring systems for determining difference values.

A collimator makes it possible in a small space to present large distances of measuring marks. Together with a telescope set at infinity, it can be used to determine differences of direction. In the basic measuring strategy, the lens of a telescope projects a image of a mark in the focal plane. If a telescope mark, for instance an angle scale, is provided in the focal plane, the difference in directions between the collimator and telescope axes can be determined from the shifting between the marks. Parallel shifting of the two axes does not affect the angle measurement. If the collimator and the telescope are arranged in parallel closely together, and a planar reflector is used for beam deflection, as well as a common lens, the result is a so-called autocollimator with geometric beam splitting. Tilting of the planar deflector from a position at a right angle relative to the axis of the lens is perceptively indicated. Compared to a single collimator, the sensitivity is doubled. In an autocollimator, the illuminated marks have to be brought into tune with each other. Among others, combinations of marks are suitable for adjustment and focusing. In an autocollimator with physical beam splitting the telescope and collimator axes coincide up to a beam splitter. This relates to the standard instrument used for most measuring applications of the kind described.

A measuring method and an arrangement for measuring differences with one and the same autocollimator are also known from German patent specification DE 198 42 190 C1. In this case, too, the stated object is the avoidance of using several measuring systems for determining difference values. This publication, upon the instant invention is based as the closest prior art, relates to the same problem but, in this case, to determining the topography of perceptively curved surfaces. Here, too, an autocollimator is used in a measuring arrangement which takes up measuring values along a scanning line for establishing differences. For improving the precision, the scanning beam is always reset vertically relative to the scanning surface. In this arrangement, too, two further autocollimators may be used to correct the angle of the pentagonal prism used as a deflection unit. These also are not used to ascertain measuring values directly; but they serve as zero indicators and may not, therefore, be considered to be measuring systems. However, the publication also mentions an arrangement for establishing differences including two autocollimators for generating two separate measuring beams and to beam deflector units for measuring one angle position each. Even though this arrangement uses two autocollimators it nevertheless applies only one measuring strategy. Moreover, the publication expressly points out that because of the unavoidable deviations of the synchronous guidance of the two measuring heads and deflector units the order of magnitude of the basic deviations is such that the attainable precision is subject to considerable limitations. Thus, this publication also gives preference to the use of a single measuring system with shifting of the measuring beam between the difference forming measuring points by a deflector unit, since the additive systematic deviations thus enter into both angle measurements and, therefore, are excluded in case of the establishment of a difference. The publication discloses, furthermore, that by using a diaphragm with two apertures in the autocollimator, the two measuring beams required for measuring a difference may be formed by a single beam. It is thus known that an autocollimator cannot only emit one measuring beam but also, at least, two.

The mentioned actions notwithstanding, it is not possible, because of occurring systematic deviations, with the known measuring methods and arrangements to maintain measuring accuracies of the kind which will be increasingly required in novel applications, particularly for optical components with dimensions between 30 mm and 1,200 mm and sharper curves. In this connection, the technical goal to be mentioned is a precision of measuring deviations from an ideal shape of angles of inclinations of 0.01 seconds of arc, which in practice cannot currently be attained, however. The attainable 0.08 seconds of arc being insufficient, the object of present the invention is seen in attaining a mean measuring precision of less than 0.01 seconds of arc rms (less than 50 nrad rms) when detecting the mean deviations of inclination of technically polished surfaces. In this context, the variety of the shapes of specimens and components to be measured and the high sensitivity of the surfaces to be measured are to be taken into consideration. Furthermore, a short and automatic measuring process and a flexible use of apparatus is to be possible. The accomplishment of the invention may be gleaned from the main method claim and from the associated systems claim. Advantageous embodiments of the invention may be gleans from the corresponding subclaims. They will hereafter be explained in greater detail in connection with the description of the invention.

The essential concept of the measuring method in accordance with the invention and of the precision measuring apparatus for executing the method is the combination of two or more different measuring strategies or optical measuring systems in a hybrid arrangement. An overview of the prior art has shown that this constitutes an unusual measure which in the invention yields a surprisingly great success. By contrast with the known teaching to avoid, if possible, several measuring strategies or systems, with the prior art teaching only the use of similar measuring systems, the invention teaches the deliberate combination of two or more measuring strategies using specific but known measuring and evaluation strategies and, correspondingly, of a plurality of measuring systems differing, if possible, in their occurring systematic deviations of measurement. Preferably, this may be a combination of the collimation measuring strategy and of the surface profile measuring strategy. By means of an autocollimator preferred for executing the corresponding measuring strategy and a long trace profilometer (LTP) identical measuring sites, or chronologically and/or spatially offset measuring sites, are simultaneously scanned in order to yield the required highly precise measurement result from the differentiated observation of the obtained measurement results. This makes use of the fact that the LTP always provides two measuring beams (with, in one embodiment of the invention, the reference beam in the surface profile measuring strategy or LTP being preferably used as a measuring beam by deflecting the reference beam to the specimen), the autocollimator usually provides one measuring beam. However, the prior art also discloses arrangements which use at least two measuring beams (see German patent specification DE 198 42 190 C1). Such an autocollimator with two or even more measuring beams, which always enclose a set angle, may advantageously be used in the context of the invention for increasing the number of the differing measuring sites for this measuring strategy. A further differentiation of the association of individual measuring beams with the given measuring strategy or given measuring system may take place in accordance with another embodiment of the invention, by using measuring beams of differing wavelengths which are detected by appropriate filtering and are assigned to appropriate measuring strategy. Thus, detected measuring beams at one and the same measuring site and at the same measurement point in time may in a simple manner be nevertheless assigned to the different measuring systems. In principle, the measuring method in accordance with the invention allows the use different measuring strategies of different resolution. However, where the used measuring strategies are to ensure the same resolution, it is advantageous in accordance with an embodiment of the invention to generate substantially equally sized scanning sites by the used measuring beams. Measuring beams of equal diameter are then generated by the use of identical apertures.

The scanning of chronologically and/or spatially offset measuring sites by different measuring beams of approximately equal beam diameter is based upon the recognition that during a measuring operation or as part of the result of each measurement it is necessary constantly to analyze the manifold influences by the measurement deviations which are distinguished according to accidental and systematic errors. The accidental deviations must be constantly detected, analyzed and, where necessary, incorporated as a control parameter into the process for correcting the conditions give rise to them, into the measuring operation and into the result of the measurement. In accordance with a further embodiment of the invention it is advantageous in a computer-assisted control of the slidable elements to provide for a combined cooperation with the measuring values detected by the at least to different measuring strategies, in special measuring and adjustment strategies after semi or fully automatic measuring and specimen adjustment strategies and for storing the measuring and position values in a storage unit. To accomplish this, it is necessary to provide for the conditions in terms of measuring techniques in order to minimize the accidental components from the different measuring values. For this purpose, the apparatus in accordance with the invention offers, in its basic concept of executing the combined measuring operation and in its preferred advantageous embodiments, a number of effective measures. Among these are, in particular, the entire constructive design of the claimed precision measuring apparatus and the avoidance or minimization of environmental influences. This and the possibility of a rapid acceptance of large quantities of measuring data makes it possible to easily to control the accidental and statistically occurring measurement deviations, so that their effect upon the accuracy of the measurements can be reliably eliminated. It is completely different in the case of systematic measurement deviations which must be categorized according to their possible causes. However, the combination of two different measuring strategies renders them clearly recognizable, and by applying generally known evaluation strategies, such as, for instance, the difference formation, they can be compensated or eliminated, as the case may be. In this connection it is to be noted, that especially higher order measurement deviations also, which must be taken into consideration in such precisely to be determined measuring values, at similar environmental conditions for both measuring systems are also detected by the measuring method in accordance with the invention.

The long trace profilometer (LTP) may be an optical measuring apparatus for checking the surface formation of slightly or uncurved optical surfaces of large extent and highest precision, as known from the basic patent, viz.: U.S. Pat. No. 4,884,697. The LTP operates on the basis of the surface profile measuring strategy, with a double beam (the measuring and reference beam) the reflections of which from the specimen are detected at the site of a line detector. An interference image is generated at the site of the sensor the site of the image on the detector being a measure of the inclination of the specimen at any given scanned site. The inclinations of a specimen along a straight measuring path are measured directly by the LTP which, like an autocollimator, may be driven by a laser source. This makes apparent the basic difference from the measuring strategy of an autocollimator. The autocollimator can always measure and correct two values of angles disposed at right angle relative to each other, whereas the LTP in its general application measures in the longitudinal direction of the specimen only, but at a larger angular measuring range. With spherically curved surfaces in particular, the measuring range can be increased by the use of an LTP, and a greater extent of a specimen can be measured as well. By the small apertures of the autocollimator which are adapted to the measuring beams of the LTP and by the point measurements of the LTP an especially high spatial resolution can be achieved by the measuring method or with the precision measuring apparatus in accordance with the invention, as a result of the small diameters which is substantially identical for all the measuring beams. The high spatial resolution in turn ensures the quantity of measuring values important for the elimination of the accidental measurement deviations and the detection of all surface inclinations even in the smallest ranges.

The highly precise measuring method and the precision measuring apparatus in accordance with the invention which because of its attainable measuring accuracy may be called “ultra precision measuring apparatus” make possible applications in a wide field as a result of the basic combination of two different measuring strategies or systems and a number of additional advantageous embodiments. Thus, the large number of the basic shapes of the specimen surfaces to be measured may extend over a very wide range of possible constant surface formations. For instance, it is possible to measure the inclination of deviations from a plane can be measured of surfaces, cylindrical surfaces, spherical surfaces, rotationally symmetric aspherical surfaces, non-rotationally symmetric aspheric surfaces, surfaces of the shapes of basic conical sections such a ellipsoids, toroids, paraboloids or elliptical cylinders and even aspherical free forms or specimens with interrupted surfaces or surfaces bent along a sharp separation line. In general, the constantly extending curvature of the surfaces to be measured is to be subject to small localized changes in curvature. However, more pronounced curvatures may be measured as well by the use of special measuring strategies which are known per se. The variety of the component formations to be measured is not limited to circular round parts with a cylindrical edge, but it also includes rectangular shapes or shapes delimited by round surfaces even those of extreme length to width ratios or length to thickness. The sensitivity of the surfaces to be measured in respect of the risk of damage, especially in the case of coated surfaces, and in respect of cleanliness to maintain the quality for use in ultra high vacuum is taken into consideration by the two strictly optically scanning measuring systems. The optical degree of reflection differing from zero of the measured surfaces may, for instance, be between 4% and 100%. In the case of highly sensitive detectors it may even be below 4%. Short term measurements conforming to the necessary measuring accuracy may be executed without any problems, especially by the automation, in a manner particularly suitable for industrial repetitive manufacture, of the two used measuring systems in respect of the measuring operation and the exchange, adjustment and guidance of the specimen to be measured. The measuring speed may easily be adapted to the required accuracy.

The use of two different optical measuring strategies or measuring systems ensure the appearance of different systematic measurement deviations. For that reason the measuring values derived from two measuring systems at two scanning sites need only be processed to a common measurement result by suitable evaluation strategies in order reliably to eliminate any systematic errors. The appearance of differing systematic errors is, therefore, of the utmost importance. Equal systematic measurement deviations which would occur by using two identical measuring strategies or systems cannot yield the accuracy of measurement extending into the required range of accuracy. The invention thus demonstrates that it is exactly the improvement of the concept, avoided by the prior art on grounds of being disadvantageous, of using two different measuring strategies or measuring systems in a hybrid arrangement which yields results. The extremely accurate measuring results attainable by the measuring strategy or precision measuring apparatus according to the invention which will be described in the specific section of the specification, are confirming this concept. For correlation in the evaluation unit, suitable yet well known evaluation strategies of autocalibration and reduction of accidental and systematic measurement deviations from the different measurement deviations from the autocollimation telescope and the long trace profilometer have to be selected and balanced against each other. Different processes are known for autocalibrating the two measuring systems. The specimen may, for instance, be scanned repeatedly. Between scanning cycles the specimen may be rotated by 90° or 180°. Moreover, different scanning paths may be operated in parallel. Moreover, the angles of inclination in particular may be measured at the same or different positions of the specimen at the same or different points in time. The reception of two measuring values at one measuring site at one measuring time will certainly yield the least measurement deviations, whereas a chronologically shifted measurement at two different measuring sites which are sufficiently correlated for detecting a common measurement result, will yield the largest measurement deviations. Finally, it is possible in a suitable manner to combine the different species of the two measuring systems. For instance, the three measuring beams of the two measuring systems (a measuring beam from the autocollimator, and two measuring beams from the LTP, where one measuring beam may be a reference beam) or just two measuring beams (one beam from each measuring system) may be drawn upon for evaluation. In its simplest form, the evaluating correlation of the detected measuring values may be carried out, for instance, by forming a mean value. In that case the affects of the two different measuring systems are included in the weighting at a 50% share each. The difference formation of the kind previously explained in greater detail in connection with the shearing interferometry is possible as well. In the last analysis, however, the correlating processing of several measuring values to a common measurement result is a task which is generally familiar to, and solvable by, a skilled artisan on the basis of his experience. In this context, a computer-assisted evaluation can greatly simplify the solution of the requisite algorithms.

A number of constructive measures regarding the optical and mechanical requirements improves the measuring accuracy of the claimed precision measuring apparatus in accordance with the invention even further. Among these, for instance, is the aligned disposition of the optical axes of the two measuring systems, so that there is no need to take into consideration any misalignment in the deflection of the beam. Furthermore, the design of the reflecting deflection units is of significance. Advantageously, the beam deflectors may consist of two reflective planar mirror surfaces which are rigidly arranged relative to each other with an orientation of the intersecting edges at a right angle relative to the shifting direction of a measuring translation slide. This results in considerable invariance as regards tilting of the reflecting planes. It is only the occurring deviation of inclination at the polished surface of the specimen which is to be measured. The beam deflection units may also consist of double mirrors the reflecting surfaces of which are disposed at an angle of δ=45° relative to each other and the normal of the surface of which is disposed at δ/2 each relative to the emitted measuring beams of the two measuring systems and to the measuring beams reflected from the surface of the specimen. In this manner any effects of inhomogeneity from the optical glass of the pentagonal prism are avoided. Optionally, the reflective surface may also be disposed at an angle (±α, ±β) different from δ=45°, so that their surface normal is disposed at a difference of half the corresponding angle to the measuring system and to the measuring beam reflected from the specimen. Both geometric arrangements may simply be included in the evaluation strategy. Finally, it is of particular advantage to structure the deflection units as pentagonal prisms. Their invariance relative to tilting is generally known. Thus, there is no need in the precision measuring apparatus of the invention for additional optical arrangements to provide for highly precise adjustments of the pentagonal prism.

Environmental influences exert particular affects upon the accidental measurement deviations and, hence, upon the attainable measuring accuracy as well as upon the measuring method or precision measuring apparatus. Even though accidental measurement deviations can be substantially eliminated by many measuring values, it is advantageous substantially to avoid accidental measurement deviations. Among relevant measures is the protection of free light paths by longitudinally variable and steady air separation devices. In this manner interfering air turbulence around and within the light beams can be avoided. Furthermore, the structural arrangement of the apparatus over different slides relative to the support and movement of the specimen and the movement of the optical deflector units is significant. For instance, the measuring translation slide may be moved by a separate drive slide, and the two slides may be connected by a coupling which is elastically structured relative to the rotational shifting directions. In this manner interferences, for instance vibrations originating with the slide drive system, can be compensated by the elastic coupling. The measuring accuracy may be further improved by an orthogonal and parallel alignment of the slidable elements relative to each other and to the measuring beams, for instance by arranging the positioning slide at a right angle relative to the measuring translation slide the table surface of which is aligned parallel to the shifting surface and at a right angle to the direction of the measuring beams. The same holds true for an arrangement in which a carriage is arranged on the table surface of the positioning slide, with the guidance direction of the carriage being disposed parallel to the measuring translation slide. A further influential factor is the support and shifting of the specimen. For this purpose, it is advantageous to provide a precision turntable on the carriage the rotational axis of which is disposed orthogonally relative to the shifting directions of the measuring translation slide as well as of the carriage. In addition, the precision turntable may have a pivotal rotational axis for additionally executing a pivoting movement. For supporting the specimen on the precision turntable, the latter may be provided with a receiving and adjustment device for the specimen consisting of a receiving table having three support studs disposed in a rectangular, isosceles or equilateral triangle and of which at least two are vertically adjustable and the planar table surface of which is disposed parallel to the table surface of the lateral slide and which by the vertically adjustable studs may be tilted about the rectangularly disposed shifting axes of the two slides.

With a view further to improving the quality of the precision measuring apparatus in accordance with the invention, it is advantageous to control its set positions. For this purpose, the slidable elements may be equipped with measuring sensors for determining a given position. As regards setting of a precise position, it is of further advantage to provide electrical drive systems for the slidable elements. Moreover, during a measuring operation the sliding movement of the slidable elements may in cooperation with the issuance of measuring values by the two measuring systems be advantageously combined with the aid of a computer in special measuring and adjustment strategies by semi- or fully automatic measuring and specimen adjustment strategies, and the measuring and positional values may be stored in a storage unit. It is also advantageous to avoid any heat-emitting elements, or to minimize their heat dissipation, in order to keep thermal effects as low as possible. To this end all the drive and measuring systems may be operated at a very low electrical dissipation and only one drive system and the measuring systems may be operated during the measuring operations. An embodiment in which the various bearing arrangements are constituted by air bearings is of very low loss and free of friction. In the same manner as the positions and dispositions of specimens and all slidable elements can be detected by sensors, secondary sensors may additionally be provided for sensitive apparatus groups for determining differences of temperature, vibrations, relative humidity and atmospheric pressure, the measuring values of which will be included in the evaluation. Finally, in order to insulate it from the environment and, hence, detrimental environmental effects, the entire precision measuring apparatus may enclosed in a temperature insulating and substantially airtight housing.

For a better understanding, embodiment of the invention will hereafter be described in greater detail with reference to the schematic drawings, in which:

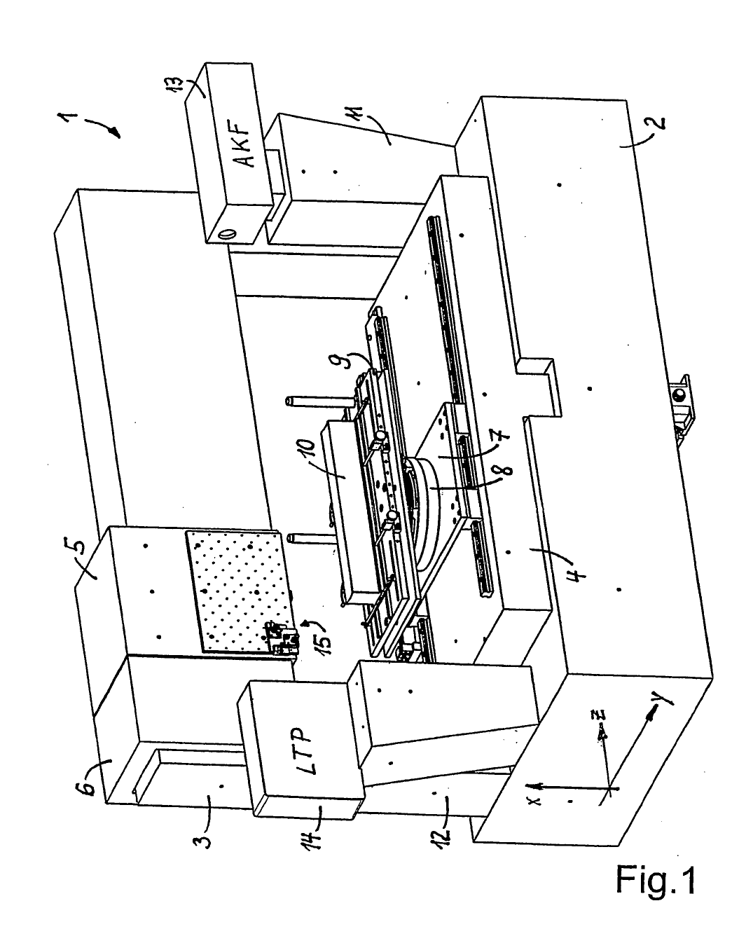

FIG. 1 depicts the basic structure of the precision measuring apparatus in accordance with the invention;

FIGS. 1-10 depict different scanning variants of the two measuring systems;

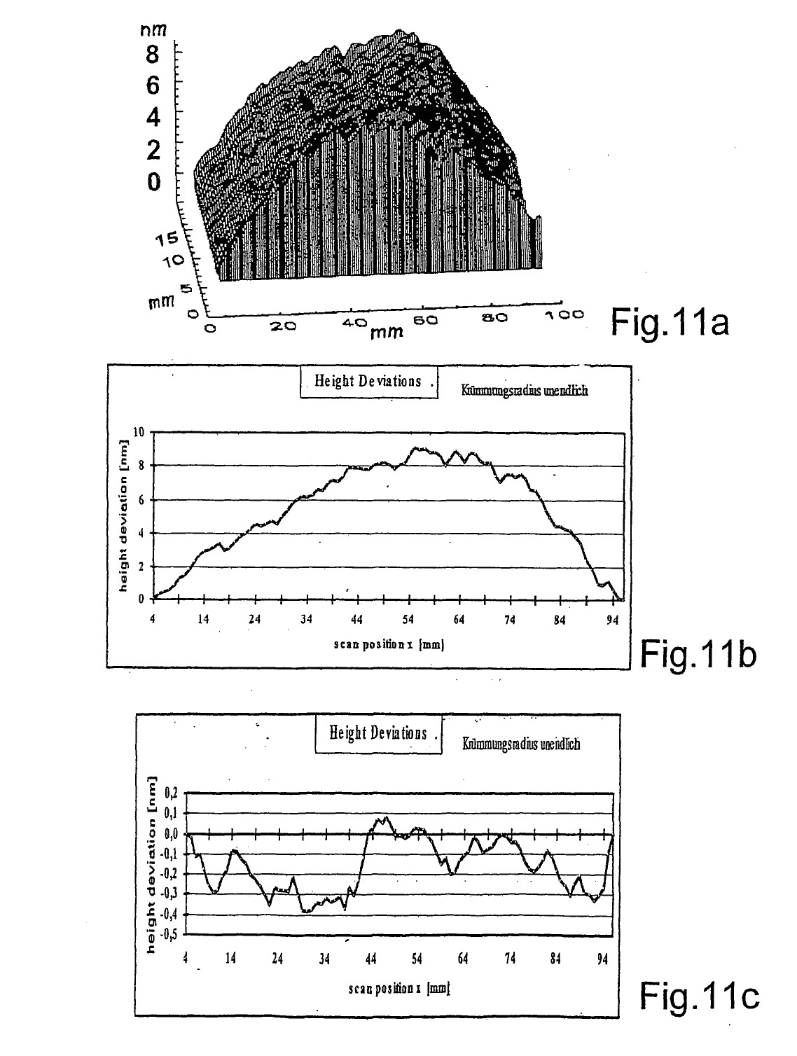

FIG. 11a represents a detected surface relief of a planar grid substrate;

FIG. 11b represents a center scan of the grid substrate of FIG. 11a;

FIG. 11c depicts the reproducibility of the measuring results on the grid substrate of FIG. 11a;

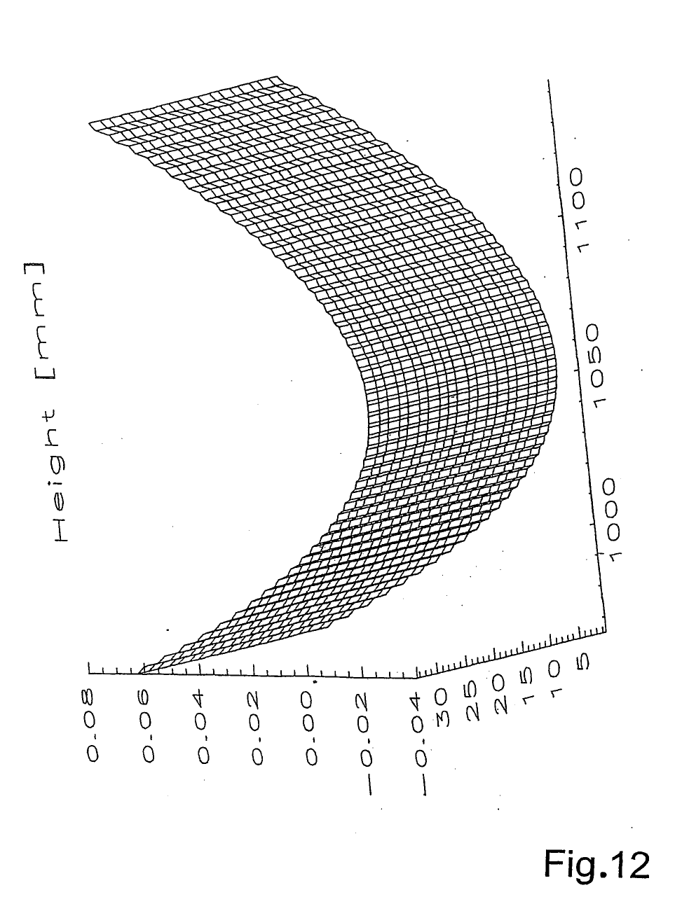

FIG. 12 shows the measuring result from an elliptical cylinder;

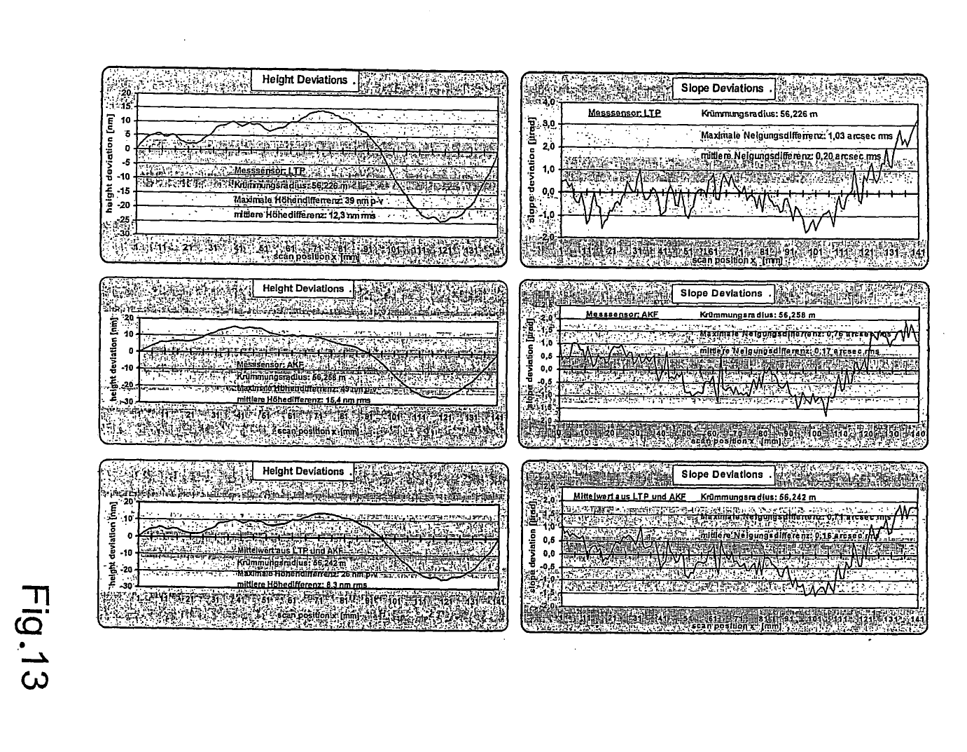

FIG. 13 depicts a comparison of measuring results; and

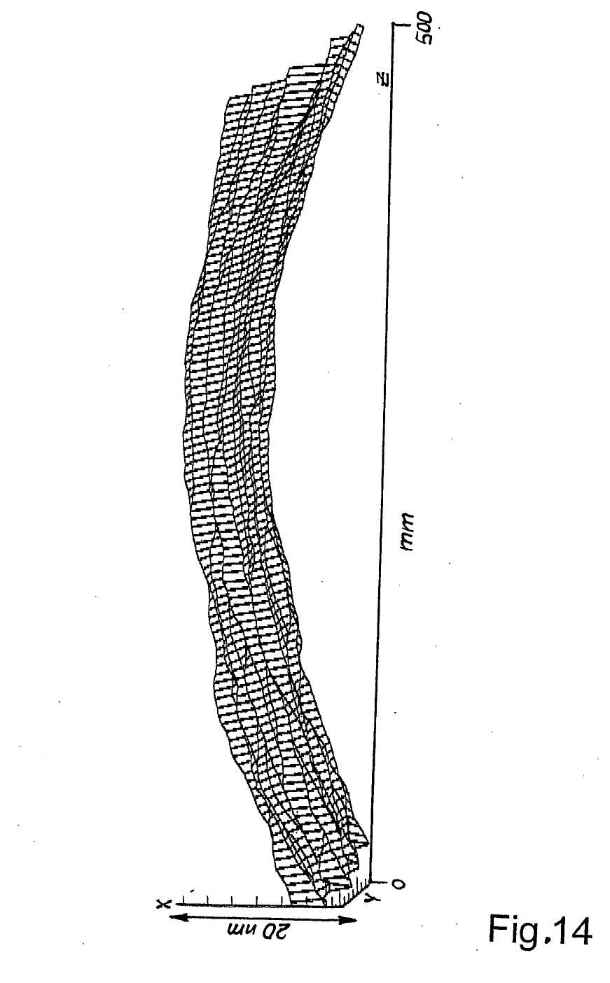

FIG. 14 depicts an elevational profile.

FIG. 1 depicts a precision measuring apparatus 1 in accordance with the invention of an attainable measuring precision into the sub nanometer range (0.01 seconds of arc rms or, correspondingly, 0.03 nm mean rms). It consists of a stone base 2 (for instance granite), upon which a stone cross beam 3 is mounted. A position slide 4 can be moved on an air cushion over the depth (y direction) of the stone base 1, rectangularly with respect to a measurement translation slide 5. The measurement transmission slide 5 is supported by the cross beam 3 and may be moved over the free width of the stone cross beam 5 (x direction). To move the slide 5, a drive slide 6 is provided which also moves on the stone cross beam 3. A carriage 7 is mounted on the position slide 4 at a right angle relative to the measurement translation slide 5, the table surface of the carriage 7 being disposed in parallel relative to the plane of movement and vertically relative to the deflecting measuring beams (see infra). On the carriage 7 there is mounted a precision turret 8 which is provided with pivotable rotational axis for executing pivotal and rotary movements by means of a pair of bearings. In the selected embodiment, a beam-like specimen 10 (P) is mounted on the precision turret 8 by means of a multiply adjustable reception and adjustment device 9.

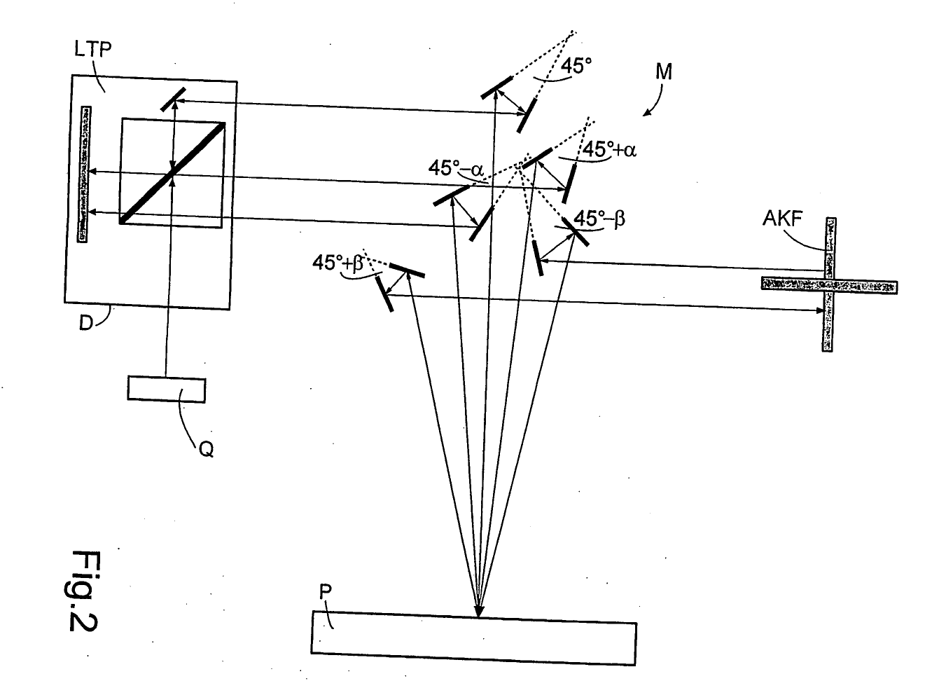

At the sides of the precision measuring apparatus 1, two measuring systems 13, 14 are placed opposite and facing each other with their optical axes in alignment, on stone supports 11 placed upon the stone basis 2. The right measuring system 13 is a autocollimation telescope AKF; the left measuring system 14 is a long trace profilometer LTP the operating strategy of which, as is well known, operates by a measuring strategy completely different from that of the AKF. By suitably correlating, in an evaluation unit not shown in the drawing, the measurement values obtained by the two measuring systems 13, 14, systematic measurement deviations can be minimized and highly accurate measurement results can be obtained, as has already been set forth in greater detail in the general description. In both measuring systems, the measuring beams are directed against beam deflection units 15 (M) which are connected to the slidable measurement translation slide 5 and which serve top deflect the beams onto the specimen 10. The beam deflection unit 15 may consist of two mirrors aligned at a predetermined angle relative to each other, or, especially, a pentagonal prism, and which are especially constant against insignificant tilting of the reflectors. Different possible embodiments of the beam deflection unit 15 and of the utilization of the measuring beam are described in connection with the following figures. The simplest case of a common beam deflection unit 15 for all measuring beams is being mentioned here for reasons of completeness. FIGS. 2 to 10 depict different possible structures of beam deflection units M, the utilization of the measuring beams of the two measuring systems AKF addn LTP and of the scanning variations at one or at several measuring points. As I well known, the AKF usually emits one measuring beam, whereas the LTP emits two measuring beams, where one of the measuring beams may be constituted by the reference beam inherent in the LTP. Each of the detection planes of the AKF (two planes) and of the LTP (usually one plane) are shown schematically. Both measuring systems require a light source for generating the measuring beams. Preferably, this is laser light source. It may be integrated in the AKF and is, therefore, not shown in the drawings. The LTP is provided with a more powerful laser which because of its heat generation is not integrated into the LTP proper; rather, it is mounted externally. This condition has been indicated in the drawings by the light source Q. Behind the light source Q there is provided a beam splitter D for generating the two measuring beams of the LTP. The corresponding angles of the reflector relative to each other within the beam deflection units M have been shown in the drawings. The 45° angle (δ) as the base angle depicts the vertical impingement of the light upon the surface of the specimen. For changing this base angle to provide oblique impingement of light, the angles α, β have been shown for the two measuring systems AKF and LTP which have to be correspondingly in a counter-directed disposition (±α,±β). Furthermore, the directions of the arrows is to be noted in order to be able to distinguish the emitted measuring beams from the reflected ones. Measuring beams impinging orthogonally upon the surface of the specimen P may be fed back to the detectors by a suitable modification of the beam deflection unit M. The indicated scans may be synchronous as well as offset in time; or they may be identical or offset in respect of site, or they may occur in any desired combination of time and site. The selection takes place dependent upon actual ambient condition and other environmental parameters (Process speed, number of measurements, evaluations, etc.).

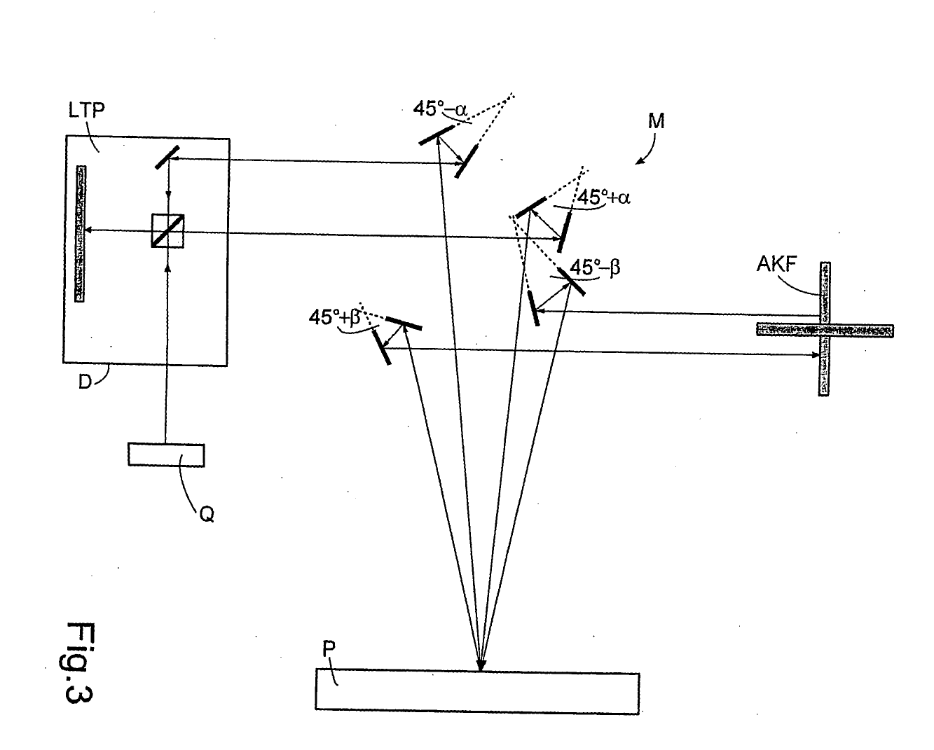

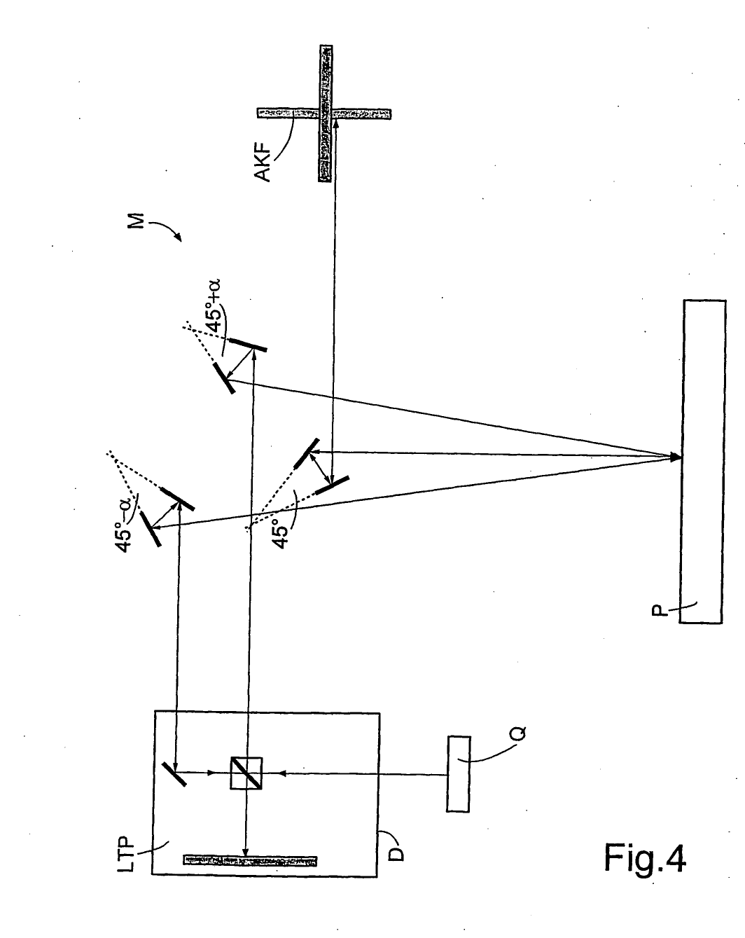

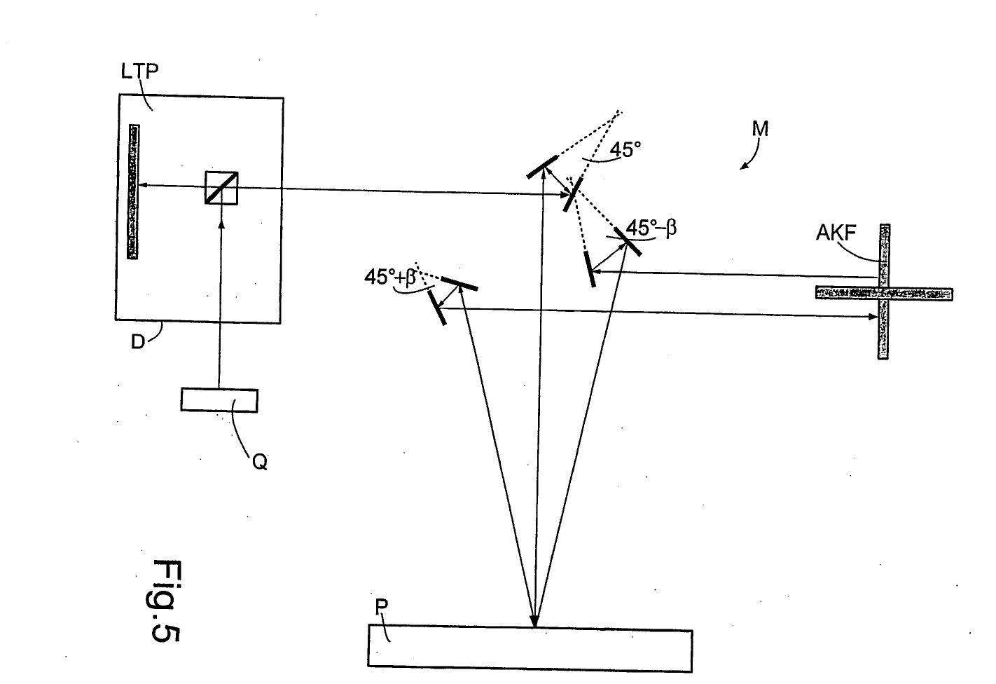

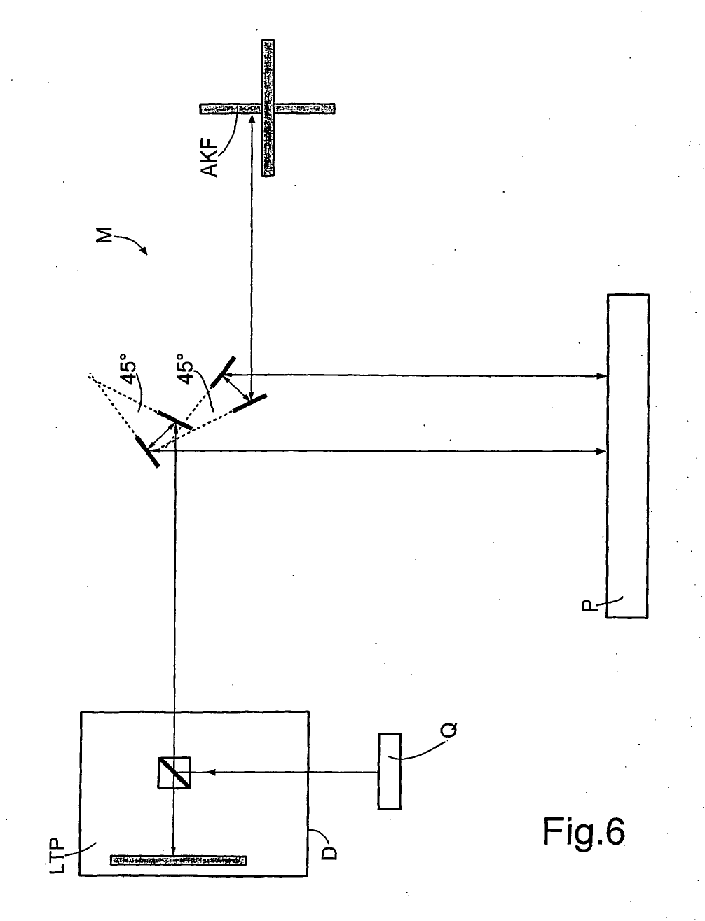

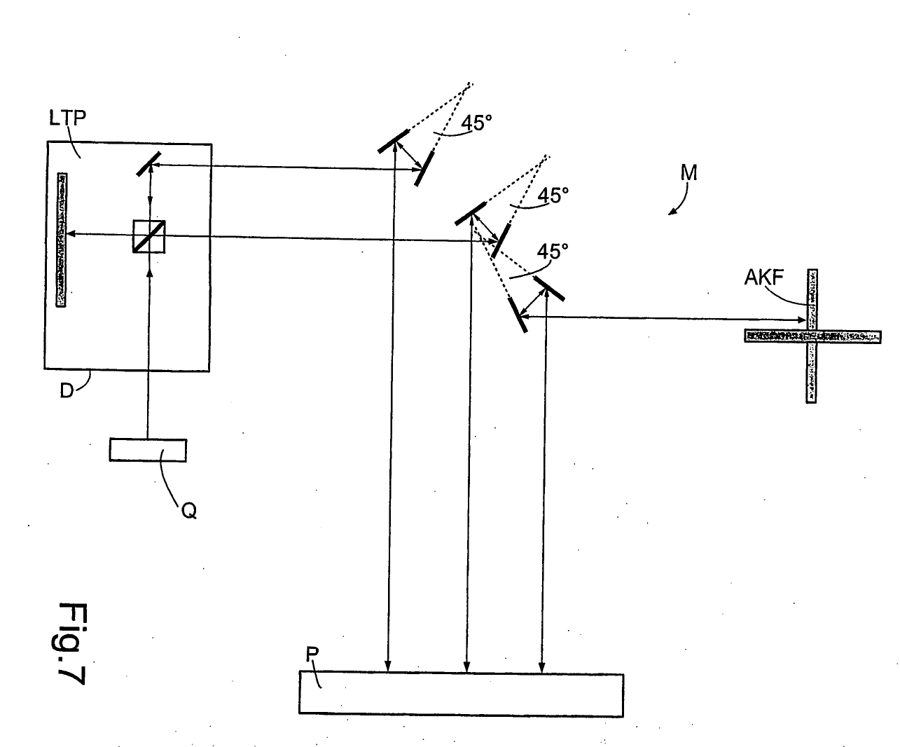

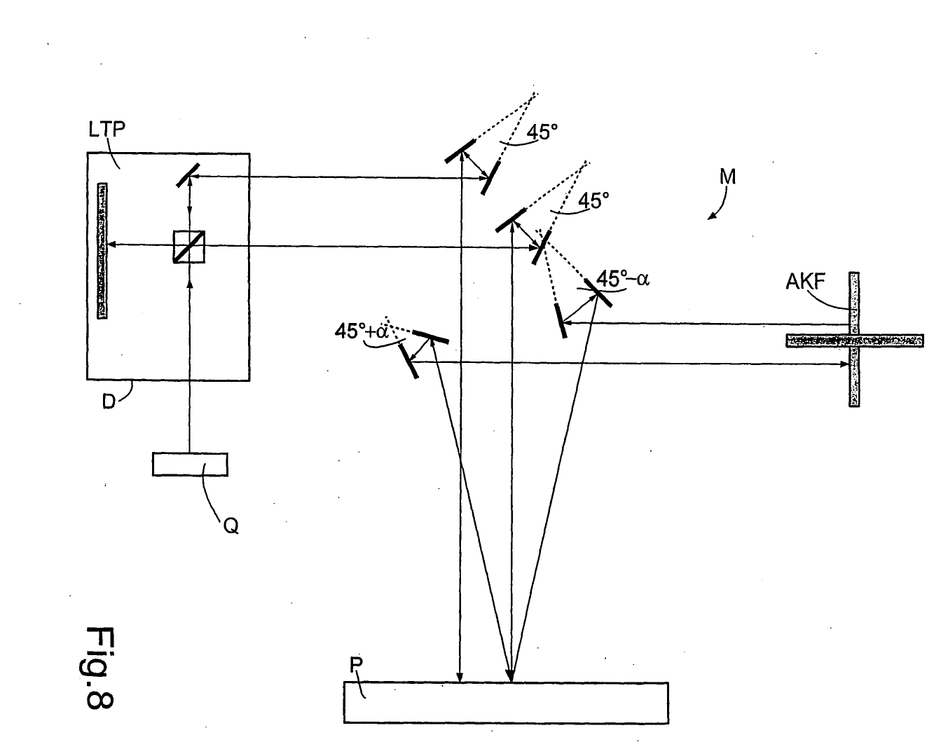

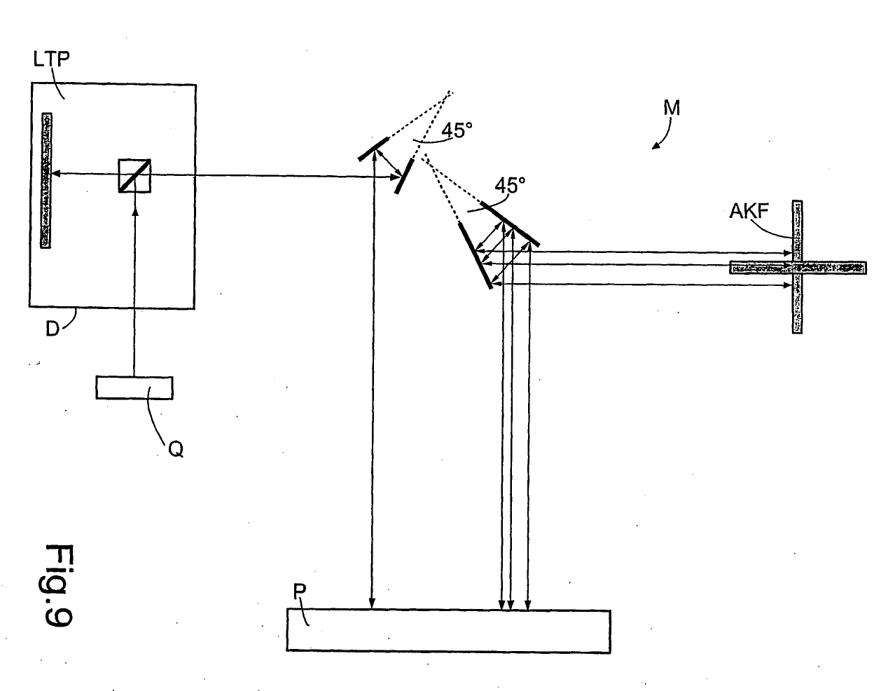

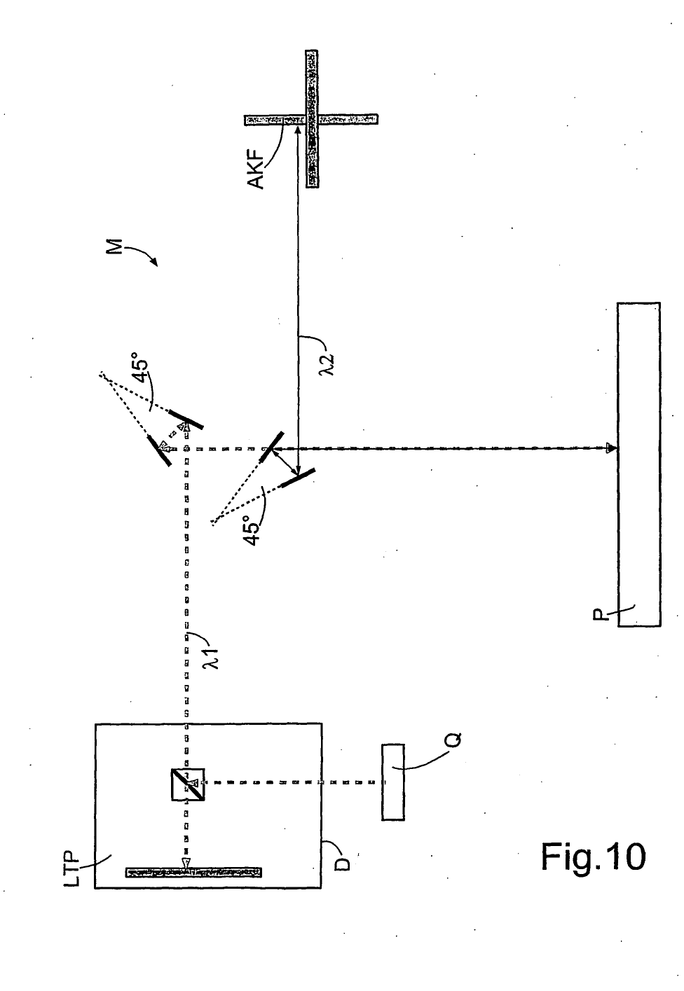

FIG. 2 depicts a spatially identical scan by a measuring beam from the AKF and two measuring beams from the LTP, one of the two measuring, beams from the LTP being vertically directed upon the surface of the specimen P. FIG. 3 depicts an identical construction, however, without the vertical measuring beam. FIG. 4 also depicts a spatially identical scan with an orthogonal measuring beam from the AKF and two measuring beams from the LTP which are not orthogonally aligned. FIG. 5 shows a synchronous or chronologically offset scan at one site with a non-orthogonal measuring beam from the AKF and an orthogonal measuring beam from the LTP. The following figures depict spatially offset scans (two or three measuring points). FIG. 6 depicts a scan with one measuring beam from each measuring system AKF, LTP, both measuring beams being orthogonally deflected on to the surface of the specimen P. FIG. 7 depicts a spatially offset scan with three measuring beams all of which are orthogonally aligned. Finally, FIG. 8 depicts a spatially identical scan of a measuring point by both measuring systems AKF and LTP and a spatially offset scan of a further measuring point which may take place chronologically offset. Both measuring beams from the LTP impinge the specimen P orthogonally, whereas the measuring beam from the AKF is impinging angularly. FIG. 9 shows a spatially offset scan of a specimen P by three measuring beams from the AKF at three different measuring points and a simultaneous scan of a further measuring point by the LTP. FIG. 10 shows a spatially identical scan of a specimen P by two measuring systems using light of different wave lengths λ₁ for one measuring system LTP and λ₂ for the other measuring system AKF. Detection takes place by appropriate filters.

FIGS. 11 to 14 depict results of measurements determined by the method or precision measuring apparatus in accordance with the invention, as the case may be. FIG. 11a depicts a surface relief of a grid substrate of mono-crystalline silicon taken and correspondingly evaluated by an AKF and a LTP. The specimen P is of a length of 100 mm at a width of 20 mm and height of 40 mm. The spatial resolution is 3 mm; 180 longitudinal traces were taken at a spacing of 0.1 mm. Over a length of 90 mm (scan position) the surface relief evinces a maximum deviation of about 8 nm. Hence, it is a highly planar grid substrate with a radius of approximately infinite curvature (100 to 200 km). The measurement uncertainty for the shape is smaller than the value of ±0.5 nm. FIG. 11b depicts a determined mean trace over an extent of 90 mm. The maximum peak to valley height is 9.1 nm. The result is a deviation of curvature of 2.7 nm rms, corresponding to 72 milliseconds of arc rms (root main square). FIG. 11c depicts the high reproducibility of the measurement curves taken of the height deviations and proves the high accuracy of the ultra precision measuring apparatus in accordance with the invention. The reproducibility as a difference of two results averaged from each of 6 measuring lines amount to from MW6 to MW8±0.24 nm peak to valley at a deviation of curvature of 0.13 nm rms, corresponding to 11 milliseconds of arc rms.

FIG. 12 depicts a three-dimensional height curve for an elliptical cylinder made of glass ceramic and of which a measuring surface of 120 mm length and 25 mm width was scanned. The spacing between measuring points was 1 mm in the x and y directions. FIG. 12 discloses the cylindrical shape of the specimen. The profile represents an ellipse the median deflection of which is 97.103 μm at a median circular deviation of ±4.684 μm. The comparison of the result of the measurement with the ellipto-cylindrical desired surface not shown here results in a median deviation of shape of the specimen of 120 nm rms.

FIG. 13 shows a comparison of the measurement result of the originally obtained deviations of inclination (right) and the deviations of height (left) derived therefrom of a spherically curved highly precise mirror used as the specimen by individually used measuring systems (LTP at the top and AKF in the middle) and their combination in accordance with the invention (at the bottom). The deviations are shown as deviations from desired coordinates of the median sphere. The lower line depicts the combination of the two individual measurement curves by averaging and zero displacement. The curve thus represents the combined overall result. The depicted results of the measurements for the deviations of inclination and height indicate that the results expressed by the numbers as maximum deviations (peak to valley) and as mean square deviation (standard deviation rms) in the combination are smaller in all cases than in the individual measurements. The reason for this resides in the different incorporation of the systematic measurement deviations of the individual sensors into the overall result. The combined result thus is more precise than the results from the individually operated measuring systems.

FIG. 14 is a presentation of the height profile of the optically effective surface of a specimen measuring 510 mm in length, 120 mm in width and 120 mm in height. The measured median peak to valley height is 20 nm. The height lines are spaced 2 mm from each other. The longitudinal radius amounts to 500 km, the measured median deviation of curvature amounts to 0.06 milliseconds of arc rms, which in the measurement by the precision measuring apparatus in accordance with the invention is exactly within the attainable range of precision.

1. An optical measuring method for determining deviations from an ideal form of technical polished surfaces of planar or curved extent of a slidably mounted specimen (10) by reference-free deflectometric scans by at least two measuring beams each of which is deflected to the surface of the specimen by slidable beam deflection units (15) and detected by the corresponding angle of reflection, the measuring beams being generated and detected by at least two different optical measuring strategies and the scanning sites dependent on the total number of scanning beams being selected as spatially and/or chronologically coincident and/or offset, and by a combining evaluation of the measurement values detected at the scanning sites as a common measurement value by application of selectable evaluation strategies of autocalibration and reduction of accidental and systematic deviations of measurement from the at least two different optical measuring strategies.

2. The optical measuring method of claim 1 with generation of scanning sites of substantially equal size by the measuring beams used.

3. The optical measuring method of claim 2 with at least two measuring beams or different wave lengths associated with the different measuring strategies which are detected by corresponding filtering and associated with the corresponding measuring strategy.

4. The optical measuring method of claim 3 with a combination of the collimation measuring strategy with the surface profile measuring strategy.

5. The optical measuring method of claim 4 with generating, by the collimation measuring strategy, several measuring beams enclosing a constant angle between.

6. The optical measuring method of claim 5 with a deflection of the reference beam in the surface profile measuring strategy as measuring beam onto the specimen.

7. The optical measuring method of claim 6 with a computer-assisted control of the slidable elements in combined cooperation with the measuring values detected by the at least two measuring strategies in special measuring and adjusting strategies and storage of the measurement and position values in a storage unit.

8. A precision measuring apparatus (1) for practicing the highly precise measuring method of claims 1 to 7 with an arrangement of the specimen (10) on a positioning slide (4) slidable over the depth of the apparatus, with a connection of the beam deflection units with a measurement translation slide (5) slidable over the width of the apparatus, with a measuring system (13, 14) including a detection unit for each measuring strategy used, the at least two measuring systems (13, 14) being positioned opposite each other at a distance extending over the width of the apparatus and arranged in parallel to each other with respect to their optical axes and the measurement translation slide (5), and with a control and evaluation unit for selecting the scanning sites and evaluating the detected measurement values.

9. The precision measuring apparatus of claim 8 with the at least two measuring systems (13, 14) arranged with their measuring axes in parallel with each other.

10. The precision measuring apparatus of claim 9 with an autocollimation telescope (AKF) for executing the collimation measuring strategy and a long trace profilometer (LTP) for executing the surface profile measuring strategy.

11. The precision measuring apparatus of claim 10 with a structure of the beam deflection units (15) of two reflecting planar mirror surfaces rigidly arranged with the intersection margins at a right angle relative to the sliding movement of the measurement translation slide (5).

12. The precision measuring apparatus of claim 11 with a structure of the beam deflection units (15) of double mirrors the reflective surfaces of which being disposed relative to each other at an angle of δ=45°±α, β and the surface normal of which being disposed at δ/2 relative to the emitted measuring beams of the measuring systems (13, 14) and relative to the measuring beams reflected from the surface of the specimen (10).

13. The precision measuring apparatus of claim 12 with a structure of the beam deflection unit (15) as a pentagonal prism.

14. The precision measuring apparatus of claim 13 with a protection of the free light paths by longitudinally adjustable and rigid air separation devices.

15. The precision measuring apparatus of claim 14 with sliding of the measurement translation slide (5) by a separate drive slide (6) the connection between the two slides (5, 6) being established by a coupling elastically mounted in the rotational sliding devices.

16. The precision measuring apparatus of claim 15 with a rectangular arrangement of the position slide (4) relative to the measurement translation slide (5), the table surface of the latter being disposed in parallel relative to the sliding surface and at a right angle relative to the direction of the deflected measuring beams.

17. The precision measuring apparatus of claim 15 with an arrangement of a carriage (7) guided on the table surface of the position slide (4) in parallel relative to the measurement translation slide (5).

18. The precision measuring apparatus of claim 17 with an attachment of a precision turret (8) on the carriage (7) the rotational axis being orthogonal relative to the sliding directions of the measurement translation slide (5) as well as the carriage (7).

19. The precision measuring apparatus of claim 18 with a structure of the is precision turret (8) with a pivotable rotational axis for the additional execution of a pivoting movement.

20. The precision measuring apparatus of claim 19 with an arrangement of a receiving and adjusting device (9) for the specimen (10) on the precision turret (8) consisting of a receiving table having three supports disposed in a rectangular, isosceles or equilateral triangle at least two of which are vertically adjustable and the planer table surface of which is disposed in parallel relative to the table surface of the carriage (7) and which by the vertically adjustable supports may be tilted about the rectangularly disposed sliding axes of the carriage (7) and measurement translation slide (5).

21. (canceled)

22. (canceled)

23. (canceled)

24. (canceled)

25. (canceled)

26. (canceled)
